(19) United States
(12) Patent Application Publication
(10) Pub. No.: US 2014/0318241 A1
(43) Pub. Date: Oct. 30, 2014

(54) Method for sensing the skid of a vehicle

(71) Applicant: Onur Gurler, Rutherford, NJ (US)

(72) Inventor: Onur Gurler, Rutherford, NJ (US)

(21) Appl. No.: 14/120,556

(22) Filed: Jun. 4, 2014

(51) Int. Cl. G01P 3/00; B60W 30/02

(52) U.S. Cl. CPC G01P 3/00; B60W 30/02
USPC 73/488

(57) ABSTRACT

The present invention relates broadly to vehicles with tires that operates on a surface, which are prone to skid, lose control and involve in an accident.

### BACKGROUND OF THE INVENTION

The present invention relates broadly to vehicles, and more particularly to a sensor that is capable of sensing if the vehicle is moving forward as well as sideways.

Vehicles were used throughout the world history, for transportation purposes. Invention of internal combustion engines sped up vehicles, which rendered them prone to loss of control and involve in accidents causing damage to the vehicle as well as surroundings. In the U.S., vehicle accidents due to loss of control causing casualties and losses measured in millions of dollars every year.

As technology advances car makers employ means to reduce loss of control for instance, intervention of vehicle computer to rectify vehicle's condition. Vehicle computer needs broad information from sensors to decide if a skidding condition is happening.

In this regard this method provides precise information to the vehicle computer regarding if the vehicle has lost control or not and also, moving to which direction at what magnitude. With help of this information it is easy for the computer to decide what means to employ at the precise moment.

### BRIEF SUMMARY OF THE INVENTION

This method optically measures the axial movements of a vehicle and feeds the information to the vehicle computer system and/or operator. Sensor module is mounted to the chassis of the vehicle; where its optical sensor looks towards the surface where the vehicle is operated on.

Sensor module uses an optical image processor with a lens adapted to focus on to the road surface, optically acquiring images of the surface of the road and measures the vehicle speed in both the direction of travel and the axis perpendicular to it. The calculated information used by the “stability-computer” to determine vehicle's velocity and its actual direction of movement in comparison to the data input from the user, steering wheel, accelerator pedal and brake pedal data.

The stability computer determines if there is a loss of traction and addresses the corrective action to regain control of vehicle.

### BRIEF DESCRIPTION OF THE SEVERAL VIEWS OF THE DRAWINGS

The subject matter regarded as the invention is particularly pointed out and distinctly claimed in the concluding portion of the specification. The invention, however, both as to organization and method of operation, together with the features, objects, and advantages thereof, may best be understood by reference to the following detailed description when read with the accompanying drawings in which:

FIG. 1 is a plan view of a vehicle with 4 tires performing turning action on a plain surface. The steering axis is the vehicle's front axis, with front tires turned towards left direction and vehicle is moving towards the top of the page. Tire resistance vectors are shown as the perpendicular lines shooting out from all tires and intersecting at the point called “center point of turning”. The vehicle turns around the “center point of turning”. In the steering axis the tire close to turning center has a larger angle with the vehicle's front direction, while on the same axis; the tire further from the turning center has a smaller angle with vehicle's front direction. As a result all tires follow a different curvature of turning and all having a different radius of turning. The vehicle remains in contact with the road. The tires and the tire-road contact points have the same linear velocity. At this condition, friction coefficient between the road and tires is called “static friction coefficient”.

FIG. 2 depicts a condition where the vehicle is skidding while turning a curb. If one of the tires of the vehicle loses contact with the surface and both the road and the tire having a different linear velocity, the vehicle considered to be skidding and is prone to get out of control. The tires lose control first are usually the rear tires of the vehicle. In this condition vehicle is governed under a smaller frictional force called the “dynamic friction coefficient”. Vehicle travel angles change; and becomes larger under skidding conditions, in this condition it has become 51° raised from 22°, due to vehicle rear wheels losing contact with the road, and behaving mostly under inertia forces.

### DETAILED DESCRIPTION OF THE INVENTION

The sensor module utilizes an optical image processing module to measure the speed of vehicle in two major directions. To define these directions, “Y Axis” is the direction the vehicle travels and perpendicular to this axis, there is the “X Axis”, which the vehicle skids towards this direction when loss of control happens.

Breakdown of the components that forms the sensor module are optical Sensor (image processing single chip computer), optical lens or lenses, light source for the optical sensor (optional), transmission protocol.

Optical Sensor module: The sensor module measures changes in position by optically acquiring sequential surface images (frames) and mathematically determining the direction and magnitude of movement. These images are processed by the sensor to determine the direction and total displacement.

The sensor calculates the Delta X (ΔX) and Delta Y (ΔY) relative displacement values in a certain time frame and returns data, denoting the distance traveled since last measurement. The sensor is capable of capturing frames in high speeds in a variance of resolutions.

Optical Lens: A concave lens is used to focus the road surface on the optical sensor. A focusing mechanism can be used to automatically focus on travel surface, incase of weight or road conditions changes.

Light source: Optical sensor requires the surface be illuminated by a light source. This light source should be powerful enough to adequately illuminate the surface from a distance to help optical sensor successfully acquire images of the road. Light source can be high from travel surface to avoid interaction. Light source can be infrared, visible light or ultra violet light, depending on the design needs.

Transmission protocol: The microcontroller transfers the information in distance traveled, vehicle's velocity, and acceleration in both directions X and Y; surface quality parameters such as; dry, wet, snowy, dirt road, stabilized road conditions; and distance of sensor from the road's surface.

The sensor assembly can be installed on an axle, which its tires are fixed. Fixed tires cannot pivot or are unable to create an angle with vehicle's direction of travel. This is usually the rear-most axle of the vehicle.

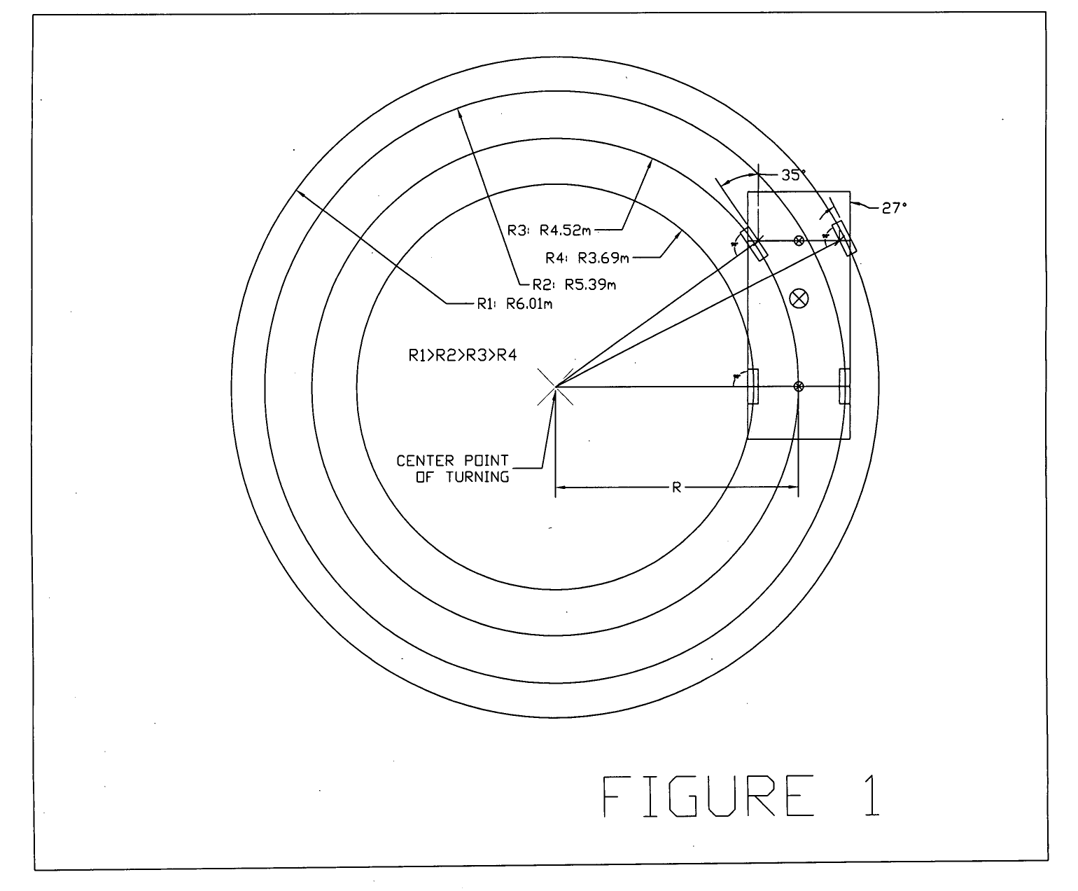

While referring to FIG. 1, turning to one direction happens when front tires of the vehicle are pivoted to some angle, until all tire's perpendicular axes intersect at some definite point. This point is called “Center point of turning” and the distance from this point to all tires center's are called radii of turning; and intrinsically all these distances are different from each other. FIG. 1 shows these different pivoting angles and resulting different turning radii.

In most vehicles the rear tires are fixed toward forward direction; this causes the rear axis to be stagnant in “X” direction of the sensor, under normal conditions. Normal conditions defined as the rear axis traveling on “Y” direction only, and skidding or movement on “X” direction is zero (0) or is not happening.

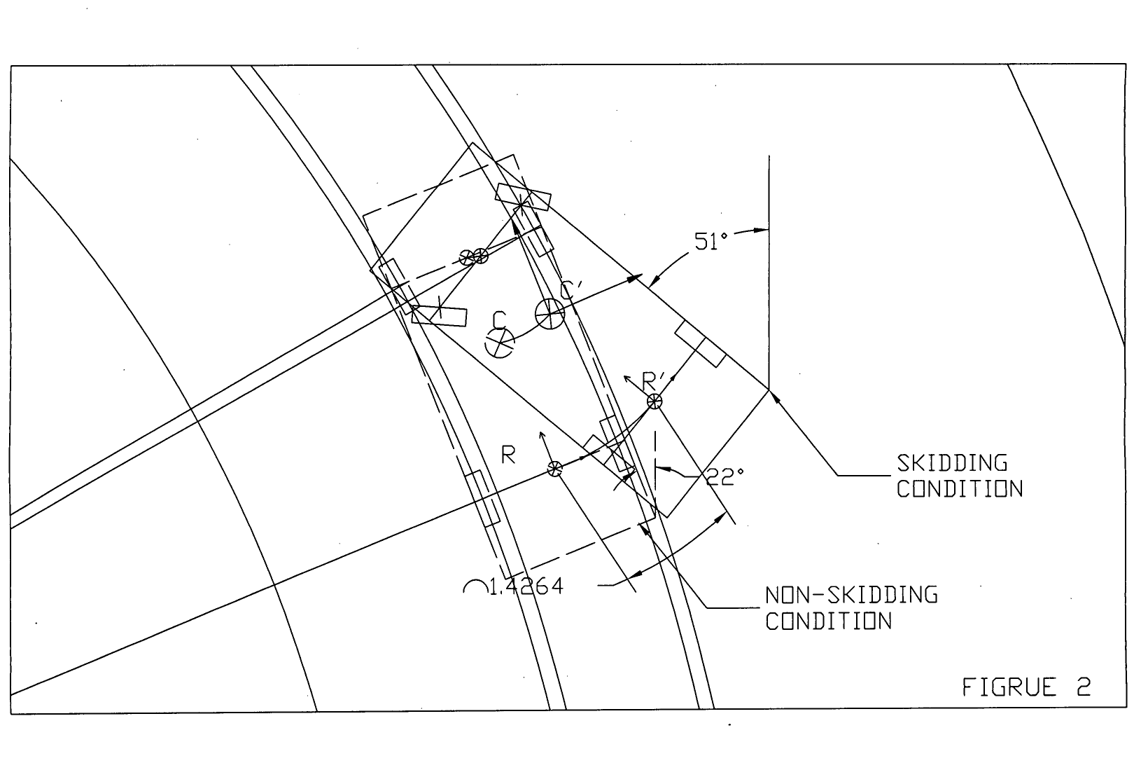

FIG. 2 shows skidding conditions, which are defined as; at least the rear axle or all axles of the vehicle is moving in both “X” and “Y” directions. In this condition, sensor returns the distance traveled in both directions and the measurement time frame data to the stability computer of the vehicle. From this information the computer can calculate how much the vehicle is displaced, its resultant displacement direction, its skidding angle relative to previous direction of travel and its velocity and acceleration of skidding; it can take precise corrective action, for a calculated duration; or can monitor the vehicle's motion continuously and change corrective action's magnitude in real time.

FIG. 2 depicts non skidding conditions to provide a comparison to skidding conditions. When vehicle skids the vehicle's total pivot angle is higher than it is supposed to be (in this case 51 degrees vs. 22 degrees). The vehicle actually manages to pivot itself to the driver's commands with help of limited friction forces transferred to the road's surface but these forces are too little and unable to overcome governing inertia forces (velocity and rotationally induced). The resultant behavior of vehicle is a combination of all forces combined.

This sensor module can be installed on both back and front of the vehicle, allowing the stability computer to compare front and rear velocities and supply extra precision in interpreting if skidding has started. Also vehicle speed comparison is possible between this sensor and ABS system's tire speed sensors, allowing the stability computer to figure if skidding might start due to a locked tire. Note that tire speed sensors can measure only tire rotation speed, which is in only one direction; and it is assumed that if the sensor module returns a value of zero the tire is locked and lost contact with the road and started skidding. However skidding of the pertaining axle may not be the case, due to other tire remains in contact with the road.

This sensor module is capable of identifying road conditions through processing of acquired images; intrinsically different travel surface conditions will produce different images.

This sensor module can be installed on rear axes of trucks, or tractor trailers, which will let the driver know if a rear tire brake lock happened and an undesired skidding due to inertia forces is happening or not, on real time.

This sensor can be installed on two axle vehicles multiple axle vehicles, as well as motor cycles bikes; all vehicles operate on land, sea or in the air.

1- A vehicle moving on a surface comprising:
A frame, chassis, or body having singular or multiple parts pivotally or rigidly connected to each other with at least two or more axles;
A sensor body connected to the frame, chassis, body adapted to measure speed and/or velocity in the direction of major travel and in the axis perpendicular to it.

2- The sensor of claim 1, might require an electro magnetic wave source to measure said speed and velocities.

3- The sensor of claim 1, might require a mechanical wave source traveling in a medium to measure said speed and velocity.

4- The sensor of claim 1, might optically, electro-magnetically, magnetically or mechanically measures the said speed and velocities.
